(19) United States
(12) Patent Application Publication
(10) Pub. No.: US 2020/0286122 A1
(43) Pub. Date: Sep. 10, 2020

(54) HUMAN BEHAVIOR AND INTERACTION INFLUENCE SYSTEM

(71) Applicant: Jacqueline M. Lasdon, New York, NY (US)

(72) Inventor: Jacqueline M. Lasdon, New York, NY (US)

(21) Appl. No.: 16/812,470

(22) Filed: Mar. 9, 2020

Related U.S. Application Data
(60) Provisional application No. 62/815,082, filed on Mar. 7, 2019.

(51) Int. Cl. G06Q 30/02; G06Q 50/00; G06K 7/14

(52) U.S. Cl. CPC G06Q 30/0251; G06K 7/1417; G06Q 50/01

(57) ABSTRACT

A human behavior influencer having a database, a proximity detector, and an interaction controller is provided. The database stores communication rules, the proximity detector receives location information from one or more mobile devices over a network, and determines, for each of the one or more mobile devices, a client-device proximity indicating the proximity between the mobile device and each other of the one or more mobile devices. The interaction controller communicates, over the network, an informational message to at least one of the one or more mobile devices based at least on the mobile-device proximity of the at least one mobile device and at least one of the plurality of communication rules, thereby causing the at least one mobile device to output an audiovisual content item.

### CROSS REFERENCE TO RELATED APPLICATIONS

This application claims priority to, and the benefit of, U.S. Provisional Patent Application Ser. No. 62/815,082, filed Mar. 7, 2019, which is hereby incorporated by reference in its entirety.

### TECHNICAL FIELD

Example aspects described herein relate generally relate to mobile device communication systems, and more particularly to mobile device systems and methods for influencing human behavior and interactions.

### BACKGROUND

Humans have been meeting and interacting with other humans since the very dawn of the species. In the modern age, however, the simple act of finding a basis to meet someone has become more challenging for some. Traditionally, people met both friends and romantic partners through family, friends, places of worship, and jobs. Somewhat more modern ways include chatting with strangers in a bar or club, meeting someone over the internet, or the use of smart phone applications like Tinder or Grindr.

It is well documented that people in both developed and developing nations are spending more and more time on devices such as electronic games, smart phones and other mobile devices. This technological interaction can, at times, hinder an individual's ability to meet people, even in an otherwise social environment. It has become nearly cliché to note how many people go to a bar or club and sit, staring at their phones, communicating through social media applications or taking selfies, rather than dancing or otherwise interacting with other people in an objectively social setting. A person staring at their phone is both less likely to reach out to meet someone new, and appears less open to another person who may wish to interact. For some, this may be a manifestation of shyness or reflect a lack of practice in meeting other people—whether for romantic or platonic reasons. In those cases, the person may actually wish to meet someone, but lacks the basis to start a conversation or the sophistication to signal their interest.

Concurrent with this trend, nightlife venues are competing to attract patrons. Modern people have become inundated with advertising in all areas of life. Social media and search engines have nearly perfected targeted ads for large groups of people, but do not well support direct communication between a place of business and interested potential customers. Furthermore, to the extent venues communicate through email, instant messages, or other social media means, modern people have become jaded to such messages. This is, in part, because such messages often come at unwanted times and in unwanted ways. For example, a bar spamming drink specials to a person in the middle of their workday is unlikely to find an available potential patron. Meanwhile, that same person, later in the evening, may be debating which club to go with their friends and may welcome timely information regarding drink specials—but be unable to find such.

New electronic devices and social applications and platforms can unfortunately decrease human interaction. Social networking services, such as dating services, connect users that may be interested in meeting one another. Such technologies form connections, associations, or other relationships with other users based on real-life interactions, online interactions, or a wide variety of other bases. However, such technologies depend on users being self-motivated to meet, and even when they do, the tendencies of users is to revert to looking down at their smart phones. One problem with existing technologies is that they do not encourage, much less require, users to put down their devices. What is needed is a technological solution to encourage willing interaction between people and other interested people and venues. Ideally, such a system would be end-user driven such that the user would interact with other people and participating venues when and how they desire, rather than feeling undue pressure or untimely messaging.

### SUMMARY

The foregoing and other limitations are overcome by a system, method, and non-transitory computer medium storing instructions for encouraging interaction between individuals and other participating individuals or participating venues.

In one example embodiment, there is provided a system for influencing human behavior, comprising: a database configured to store a plurality of communication rules; a proximity detector configured to: receive location information from one or more mobile devices over a network and determine, for each of the one or more mobile devices, a client-device proximity indicating the proximity between the mobile device and each other of the one or more mobile devices; and an interaction controller configured to: communicate, over the network, an informational message to at least one of the one or more mobile devices based at least on the mobile-device proximity of the at least one mobile device and at least one of the plurality of communication rules, thereby causing the at least one mobile device to output an audiovisual content item.

In some embodiments, the informational message contains at least one of (i) a vendor-related offer, (ii) character-related information, (iii) item information, (iv) proximity information associated with at least one of the one or more mobile devices, or (iv) any combination of (i), (ii), (iii), and (iv).

In some embodiments, the interaction controller is further configured to: receive a client-device message from at least one of the one or more mobile devices; process the client-device message based on at least one the plurality of rules; and transmit another informational message to at least the one of the one or more mobile devices.

In some embodiments, the received client-device message contains information related to communication between the client-device and another client-device over a close communication medium. In some embodiments, the close communication medium comprises one of the following: (i) infrared communication; (ii) nearfield communication; (iii) Wi-Fi; or (iv) any combination of (i-iii). In some embodiments, the interaction controller is further configured to receive, over the network, a vendor-message from a vendor device, a the vendor-message containing at least the vendor information. In some embodiments, the proximity information communicated to a handheld client device includes data indicating at least (i) a location of at least one other handheld client device, (ii) a distance between two or more mobile client devices, or both (i) and (ii). In some embodiments, the proximity information communicated to the one or more mobile devices includes data indicating at least (i) a location of the vendor device, (ii) a distance between at least one of the one or more mobile devices and the vendor device, or both (i) and (ii). In some embodiments, the interaction controller is further configured host communications among the one or more mobile devices.

In another example embodiment, there is provided a method for influencing human behavior, comprising: storing a plurality of communication rules; receiving location information from one or more mobile devices over a network, determining for each of the one or more mobile devices, a client-device proximity indicating the proximity between the mobile device and each other of the one or more mobile devices; and communicating, over the network, an informational message to at least one of the one or more mobile devices based at least on the mobile-device proximity of the at least one mobile device and at least one of the plurality of communication rules, thereby causing the at least one mobile device to output an audiovisual content item. In some embodiments, the informational message contains at least one of (i) a vendor-related offer, (ii) character-related information, (iii) item information, (iv) proximity information associated with at least one of the one or more mobile devices, or (iv) any combination of (i), (ii), (iii), and (iv).

In some embodiments, the method further comprises: receiving a client-device message from at least one of the one or more mobile devices; processing the client-device message based on at least one the plurality of rules; and transmitting another informational message to at least the one of the one or more mobile devices.

In some embodiments, the received client-device message contains information related to communication between the client-device and another client-device over a close communication medium. In some embodiments, the close communication medium comprises one of the following: (i) infrared communication; (ii) nearfield communication; (iii) Wi-Fi; or (iv) any combination of (i-iii).

In some embodiments, the method further comprises receiving, over the network, a vendor-message from a vendor device, a the vendor-message containing at least the vendor information. In some embodiments, the proximity information communicated to a handheld client device includes data indicating at least (i) a location of at least one other handheld client device, (ii) a distance between two or more mobile client devices, or both (i) and (ii). In some embodiments, the proximity information communicated to the one or more mobile devices includes data indicating at least (i) a location of the vendor device, (ii) a distance between at least one of the one or more mobile devices and the vendor device, or both (i) and (ii).

In some embodiments, the method further comprises hosting communications among the one or more mobile devices.

In another example embodiment there is provided a non-transitory computer-readable medium having stored thereon one or more sequences of instructions for causing one or more processors to perform the methods described herein.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a block diagram of an interaction encouragement system according to an example embodiment.

FIG. 2 shows a flow diagram a user interacting with a venue both directly and through a link to an interaction server according to an example embodiment.

FIG. 3 depicts a flow diagram for a user interacting with another user both directly and through a link to an interaction server according to an example embodiment.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In addition, not all of the components are required to practice the invention, and variations in the arrangement and type of the components may be made without departing from the spirit or scope of the invention. As used herein, the terms “component” and “engine” are applied to describe a specific structure for performing specific associated functions, such as a special purpose computer as programmed to perform algorithms (e.g., processes) disclosed herein. The component (or engine) can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

### System for Influencing and Encouraging Human Interaction

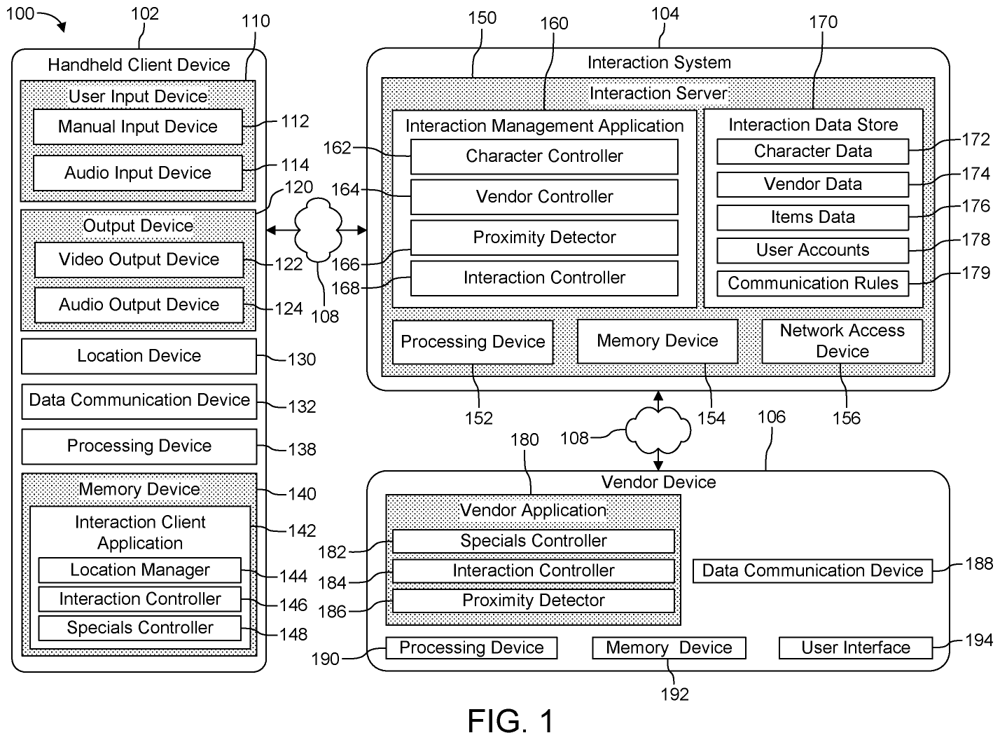

FIG. 1 is a block diagram of an example human interaction encouragement system 100. In this example, a handheld client device 102 includes a user input device 110, output device 120, a location device 130, a data communication device 132, a processing device 138, and a memory device 140.

The handheld client device 102 is a computing device. The handheld client device 102 runs an operating system capable of operating one or more application programs that perform various functions such as, for example, an interaction client application 142. The handheld client device 102 is in communication with a network 108.

In some embodiments, the handheld client device 102 is a handheld or portable entertainment device, smartphone, tablet, watch, wearable device, or any other type of computing device capable of running applications. In other embodiments, the handheld client device 102 is a laptop computer, portable gaming console, or network appliance.

The user input device 110 operates to receive a user input for controlling the handheld client device 102. In some embodiments, the user input device 110 includes a manual input device 112 and an audio input device 114.

The manual input device 112 operates to receive the manual input for controlling the handheld client device 102. In some embodiments, the manual input device 112 includes one or more buttons, keys, touch levers, switches, and/or other mechanical input devices for receiving manual input. For example, the manual input device 112 includes a text entry interface, such as a mechanical keyboard, a virtual keyboard, or a handwriting input device, which is configured to receive a text input. In addition, in some embodiments, the manual input is received for managing various pieces of information transmitted via the handheld client device 102 and/or controlling other functions or aspects associated with the handheld client device 102.

The audio input device 114 operates to detect and record sounds from proximate the handheld client device 102. For example, the audio input device 114 can detect sounds including voice input. In some embodiments, the audio input device 114 includes one or more acoustic sensors configured to detect sounds proximate the handheld client device 102. For example, acoustic sensors of the audio input device 114 include one or more microphones. Various types of microphones can be used for the audio input device 114 of the handheld client device 102.

Referring still to FIG. 1, the output device may include both a video output device 122 and an audio output device 124. The video output device 122 operates to display information. Examples of such information include interaction application information, including game information and notifications, and other information. In some embodiments, the video output device 122 is configured as a touch sensitive display and includes the manual input device 112 of the user input device 110 for receiving the manual input from a selector (e.g., a finger, stylus etc.) controlled by a user. In some embodiments, therefore, the video output device 122 operates as both a display device and a user input device. The video output device 122 operates to detect inputs based on one or both of touches and near-touches. In some embodiments, the video output device 122 displays a graphical user interface for interacting with the handheld client device 102. Other embodiments of the video output device 122 do not include a touch sensitive display screen. Some embodiments include a display device and one or more separate user interface devices. Further, some embodiments do not include a display device.

The audio output device 124 operates to output media content. In some embodiments, the audio output device 124 includes one or more embedded speakers which are incorporated in the handheld client device 102.

Alternatively or in addition, some embodiments of the handheld client device 102 include, as an audio output device 124, an external speaker interface. The external speaker interface is configured to connect the handheld client device 102 to another system having one or more speakers, such as headphones, a portal speaker, and a vehicle entertainment system, so that media output is generated via the speakers of the other system external to the handheld client device 102. Examples of the external speaker interface include an audio output jack, a USB port, a BLUETOOTH® transmitter, a display panel, and a video output jack. Other embodiments are possible as well. For example, the external speaker interface is configured to transmit a signal that can be used to reproduce an audio signal by a connected or paired device such as headphones or a speaker.

The location device 130 operates to determine the present location of the handheld client device 102. The location device 130 may determine the present location through a variety or combination of methods including GPS, triangulation of cellular signals from towers, Wi-Fi signal strength calculation, interaction with a BLUETOOTH® signal, or other methods now known or later developed.

The data communication device 132 operates to enable the handheld client device 102 to communicate with one or more computing devices over one or more networks, such as the network 108. For example, the data communication device 132 is configured to communicate with the interaction system 104 and receive interaction management information from the interaction system 104 at least partially via the network 108. The data communication device 132 can be a network interface of various types which connects the handheld client device 102 to the network 108. Examples of the data communication device 132 include wired network interfaces and wireless network interfaces. Wireless network interfaces includes infrared, Near Field Communication (“NFC”), BLUETOOTH® wireless technology, 802.11a/b/g/n/ac, and cellular or other radio frequency interfaces in at least some possible embodiments. Examples of cellular network technologies include LTE, WiMAX, UMTS, CDMA2000, GSM, cellular digital packet data (CDPD), and Mobitex.

The processing device 138, in some embodiments, includes one or more central processing units (CPU). In other embodiments, the processing device 138 additionally or alternatively includes one or more digital signal processors, field-programmable gate arrays, or other electronic circuits.

The memory device 140 typically includes at least some form of computer-readable media. The memory device 140 can include at least one data storage device. Computer readable media includes any available media that can be accessed by the handheld client device 102. By way of example, computer-readable media includes computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic storage devices, or any other medium that can be used to store the desired information and that can be accessed by the handheld client device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The memory device 140 operates to store data and instructions. In some embodiments, the memory device 140 stores instructions for an interaction client application 142. The interaction client application may include processes such as a location manager 144, interaction controller 146, and a specials controller 148.

The interaction client application 142 provides information to the user necessary to operate and interact with the interaction server 150.

In one embodiment, the interaction client application 142 may include instructions, which when executed by processing device 138 causes the processing device 138 to encourage interaction between users by rendering on output device 120 multimedia content, receiving communications messages via data communication device 132, receiving user input via user input device 110, and by using location data obtained through location device 130. The interaction client application 142 may output multimedia content representing prizes and inventory that the user may accumulate through purchase, interaction with certain venues, interaction with other users, or through successful gameplay. Reference herein to the interaction client application 142 should be understood based on the context surrounding its use to mean execution of the instructions of interaction client application 142 by processing device 138.

Such an interaction client application 142 may encourage users to meet other users in public areas to exchange or gain items, compete in competitions, or to simply be introduced through a shared interest in the interaction client application 142. The interaction client application 142 may also encourage users to frequent certain, participating venues. Such an interaction client application 142 may track attributes such as “fame,” to reflect how interactive or skilled a user is. A participating venue may offer specials, such as free or reduced-price drinks for users of the interaction client application 142, users of sufficient fame, users who arrive before or after certain times, or users who patronize the venue a sufficient number of times. An example embodiment is discussed in more detail, below.

The location manager 144 may use the location device 130 to determine the location of a handheld client device 102 of a user, thereby indicating the location of the user, transmit the location to the interaction server 150, and receive information related to the location of the user such as other users, venue information, and potential interactions. The location manager 144 may provide this location information to the interaction controller 146 or the specials controller 148.

The interaction controller 146 provides, through output device 120 of the user, information related to potential interactions to the user and uses the data communication device 132 to interact with other users and venues for either specials or interaction client application 142 interactions (e.g. inter-user competitions, trades, etc.). The interaction controller 146 may also server to allow a user to toggle and provide an indication whether they are receptive to meeting other users or interacting with venue staff. For example, a user may input, through user input device 110, an indication that marks themselves in one of several states, such as “Welcome,” (to indicate a willingness to interact with other participants) “Busy,” (to show as being in a location, but unavailable) or “Invisible,” (to hide the location of a user such that they are not visible to other users within the location). Users who too often attempt to interact within the system with “busy” or “invisible” users may cause interaction system 104 to change the features available to them. This can be, for example, through the loss of privileges or other means. Preferably, such a change in the features available to a user encourages the user to interact within the system with input indicating they are marked with the state of “Welcome”. In an example implementation, attempts to interact are counted. If a predetermined attempt threshold is met, an attempt flag is set indicating too many attempts to interact have been performed.

The specials controller 148 receives information related to the location of a user from the location manager and provides information related to potential specials to the user. If, for example, a user is not in a participating venue, the specials controller 148 may determine available specials in a radius around the user for that level of fame of the user or loyalty to venues within the radius. The specials controller 148 may then display, via output device 120, that information to the user in order to assist the user in determining a venue to attend. In another example, if the user is within a participating venue, the specials controller 148 may provide detailed information related to current and upcoming specials for that venue. Upcoming specials may include specials that will become available in a certain amount of time, specials that will become available based on increased loyalty, fame, or other score, or specials that will become available based on other bases, such as more or higher caliber users entering the venue. In this way, the user may be encouraged to invite other participants (e.g., friends) to join them at the venue.

Referring still to FIG. 1, the interaction system 104 includes an interaction server 150.

The interaction system 104 includes one or more computing devices and provides media content to the handheld client device 102 and, in some embodiments, other handheld client devices as well. In addition, the interaction system 104 interacts with the handheld client device 102 to provide the handheld client device 102 with various functionalities.

Although FIG. 1 shows a single interaction server 150, some embodiments include multiple interaction servers. In these embodiments, each of the multiple interaction servers may be identical or similar to the interaction server 150 and may provide similar functionality with, for example, greater capacity and redundancy and/or services from multiple geographic locations. Alternatively, in these embodiments, some of the multiple interaction servers may perform specialized functions to provide specialized services. Various combinations thereof are possible as well.

The interaction server 150 transmits interaction management information to devices such as the handheld client device 102. In some embodiments, the interaction server 150 includes an interaction management application 160, an interaction data store 170, a processing device 152, a memory device 154, and a network access device 156. The processing device 152 and the memory device 154 may be similar to the processing device 138 and the memory device 140, respectively, which have each been previously described. Therefore, the description of the processing device 152 and the memory device 154 are omitted for brevity purposes.

The network access device 156 operates to communicate with other computing devices over one or more networks, such as the network 108. Examples of the network access device include one or more wired network interfaces and wireless network interfaces. Examples of such wireless network interfaces of the network access device 156 include wireless wide area network (WWAN) interfaces (including cellular networks) and wireless local area network (WLANs) interfaces. In other examples, other types of wireless interfaces can be used for the network access device 156.

The interaction management application 160 may be running on the processing device 152 and be stored within the memory device 154. The interaction management application 160 serves to receive information from at least one handheld client device 102, at least one vendor device 106, and to communicate system information to those devices. The interaction management application 160 may include a character controller 162, a vendor controller 164, a proximity detector 166, and an interaction controller 168.

The character controller 162 communicates with the interaction data store 170 to manage all character-based information. Character information may relate to all information about a character of a user within an interaction client application 142, as opposed to information about the user, themselves. Character information may include current items, used items, skills, looks, benefits, levels, fame, or any other character-related (as opposed to account-based) information.

The vendor controller 164 communicates with the interaction data store 170 and vendor device 106 to manage all vendor-based information. Vendor information may relate to all information about a vendor. Vendors may include, for example, venues such as clubs or restaurants, retail sellers of goods or services such as stores or salons, or wholesale sellers such as national drink sellers or beauty product companies. Vendor information may relate to specials, loyalty, loyalty benefits, levels of vendor participation, etc.

The proximity detector 166 communicates with the interaction data store 170, at least one handheld client device 102, and at least one vendor device 106 to determine which users are within certain proximity to each other and to certain venues.

For example, the proximity detector 166 may operate by receiving location information from a plurality handheld client devices 102 of users and vendor devices 106 of vendors. It may then determine, for each of the plurality of users and vendors, a distance proximity between each user and each other user or vendor.

The interaction controller 168 may operate by communicating with the interaction data store 170 and handheld client devices 102 to manage all aspects of interaction by users with handheld client device 102 and other users. A user may interact with the interaction client application 142 solo, such as a user interacting with the interaction client application 142 by themselves to gain levels, items, experience, etc. Multiple users can interact with corresponding interaction client applications 142, interacting in competitive or cooperative manner.

The interaction controller 168 may also operate by communicating an information message to at least one handheld client device 102. In one embodiment, the interaction controller 168 may then inform each user of each other user within a certain distance, such as 100 feet. As another example, the interaction controller 168 may inform each user of certain super-users, such as celebrities, within a greater range, such as within half a mile. As another example, the interaction controller 168 may inform each user of vendors with locations within a certain distance, such as two miles. In yet another example, the interaction controller 168 may inform each user of vendors with specials, such as a venue offering drink specials or a salon offering hair styling specials within another distance, such as five miles.

Rules for when to communicate proximity information to users or vendors may be stored as part of communication rules 179 in interaction data store 170.

The interaction controller 168 may notify users of information by causing the network access device 156 to send a message to the handheld client device 102 of a user via the network 108. The sent message may cause the handheld client device 102 of the user to output audiovisual content via the video output device 122, audio output device 124, or both. Audiovisual content provided by the interaction controller 168 may include beeps, buzzes, messages, or graphics displayed on a screen. Such audiovisual content may also include music, voices, video, or animated sequences.

The interaction controller 168 may also operate by receiving a message from a handheld client device 102, processing that message based on communication rules 179, and transmitting one or more messages to one or more handheld client devices 102.

In one embodiment, the interaction controller 168 may receive a message from a handheld client device 102 of a user seeking to be introduced to a second user within a given venue. Based on the communication rules 179 of the second user, the interaction controller 168 may send a message to the handheld client device 102 of a first user notifying the user the location within the venue. Alternatively or in addition, the interaction controller 168 may request confirmation from the second user before sending their location. Finally, based on the communication rules 179 of the second user, the interaction controller 168 may decline to provide the information of the second user.

As another example, if two users meet and exchange information between their handheld client devices 102, the interaction controller 168 may receive messages from handheld client devices 102 one or both users related to the communication and may record details of the interaction of the users within the interaction data store 170.

The interaction data store 170 stores character data 172, vendor data 174, items data 176, and user accounts 178. As noted above, character data 172 typically denotes data about a character, such as items, fame, experience, or current outfits, as opposed to information about an actual user, such as name, age, address, purchase history, etc. Vendor data 174 may include information about a venue or other seller of goods, the specials associated with such vendors, location of vendors, and the types of benefits offered by the vendor, etc.

Items data 176 may include information about items, such as the texture, size, equip location, value, rarity, etc. Items data 176 may refer to item templates rather than items currently in possession of users.

User accounts 178 information may relate to information about a user participating in the interaction system 104. For example, the user accounts 178 may include the person's name, address, age, preferences, current visibility status, etc. This information is kept separate from character information and is kept more securely to prevent theft or other intrusion.

Communication rules 179 stores rules for when and how to communicate to users or vendors. As noted above, communication rules 179 may include the distances and circumstances for notifying users of nearby users, super-users, or vendors. Communication rules 179 may also include whether to communicate proximity of one user to another based on the privacy settings of one or both users. Communication rules 179 may also include determining how frequently to re-send certain alerts to a user after previously alerting the user. For example, the interaction server 150 may wish to remind users of a certain vendor special no more than once every 24 hours. Alternatively, the interaction server 150 may wish to wait a week between certain notifications, so as to not annoy the user.

Communication rules 179 may include any form of when, how, and why to communicate information to users. Communication rules 179 may be tailored based on a (i) user setting, (ii) character setting, (iii) vendor setting, (iv) global setting, or any combination of (i-iv).

In one example, memory device 154 contain one or more fashion based applications including instructions which when executed by processing device 152, cause processing device 152 to deliver multimedia content, messages or requests associated with the subject of fashion. Such a fashion based application may provide fashions from one or more types of fashion, such as Couture, Drag, EDM, Rave, Costume, etc. As a specific example, such a fashion based application may be based on a Drag fashion application called “Dungeons and Drag Queens” (D&DQ). In D&DQ, a user may acquire items such as clothing, makeup looks, shoes, or jewelry for their character. Items may also include less traditionally substantial items such as dance moves, access to certain songs, or other intangible property. These items may be acquired by purchasing within the application via in-application or real-life currency, may be achieved through participating within the application, or by meeting certain individuals/going to certain venues. The character controller 162 in D&DQ interfaces with the interaction client application 142 of a user to allow that user to set up their character to look a certain way, act a certain way when viewed by other users, and have certain background music when participating in events such as fashion shows.

Further in the example of D&DQ, the character controller 162 communicates with the interaction data store to store information about a character's setup, such as the character's outfit, makeup, and preferred dance moves. Further, the interaction controller 168 may allow users to participate in solo or competitive drag fashion shows, wearing items obtained through other gameplay. The proximity detector 166 may determine that a user is within the same venue as a famous celebrity within the application, such as a very experienced user or a celebrity spokesperson from television participating in the application. The user may then, using the location device 130 within their handheld client device 102 find the celebrity and approach them for a meeting through the interaction system 104. Assuming the celebrity consents, the user may chat with the celebrity, interact with their handheld client device 102 via Near Field Communication protocol to demonstrate that they actually spoke, and receive a special item specific to the celebrity. For example, if the celebrity is a well-known makeup artist in the real world, the application operators may provide them with a specific item, such as a certain makeup look, that they may give to users to interact with them. In such an example, either or both users may receive a bump in “fame,” making them yet more desirable for other users to interact with.

Referring still to FIG. 1, the vendor device 106 includes a vendor application 180.

The vendor device 106 is a computing device. The vendor device 106 runs an operating system capable of operating one or more application programs that perform various functions such as, for example, a vendor application 180. The vendor device 106 is in communication with a network 108.

In some embodiments, the vendor device 106 is a handheld or portable entertainment device, smartphone, tablet, watch, wearable device, or any other type of computing device capable of running applications. In other embodiments, the handheld client device 102 is a laptop computer, desktop computer, gaming console, or network appliance.

The vendor device 106 includes a vendor application 180, a data communication device 188, processing device 190, memory device 192, and user interface 194. The data communications device 188, processing device 190, and memory device 192 may be similar to the data communication device 132, processing device 138, and the memory device 140, respectively, which have each been previously described. Therefore, the description of the data communication device 188, processing device 190, and the memory device 192 are omitted for brevity purposes. Similarly, the user interface 194 may be similar to or include elements similar to the user input device 110 and output device 120, which have also been previously described. Therefore, the description of the user interface 194 is also omitted.

The vendor application 180 provides information to vendors related to the interaction system 104 and communicates with the interaction server 150 to control a given vendor's setup within the interaction system 104. For example, a vendor may wish to add, subtract, or modify specials offered within the interaction system to entice users to purchase the vendor's goods or to attend the vendor's events. The vendor may also wish to communicate such specials or invitations to users via their handheld client devices 102.

The vendor application 180 may include a specials controller 182, interaction controller 184, and a proximity detector 186.

The specials controller 182 provides a vendor an interface to manage their specials on offer, either presently or in the future. Such specials may include examples such as a free glass of the vendor's beer at certain, participating venues. Other specials may come from a venue such that participants of the system are charged less cover when they display the application, or are given priority entrance if they arrive before a certain time, or are given special perks if enough participants are at the venue during a certain period. Other specials might include lower prices for participants who frequent the venue regularly. Other specials might include lower prices for participants with sufficient fame. The possibilities for specials based on time, location, game levels or fame, items, etc. is nearly infinite. The specials controller communicates each vendor's choices for such specials to the interaction server 150.

The interaction controller 184 provides the vendor with a way to interact with users (or even other vendors). For example, if a participant wishes to claim an advertised special, they may present their handheld client device 102 to have a QR code scanned, or NFC scanned, or network interaction, or any other method of communication between the data communication device 132 and data communication device 188. Once the handheld client device 102 is scanned, the participant receives their special, either in-game or in real-life, and the interaction controller communicates the interaction to the interaction server 150. Such communication prevents the participant from claiming the benefit multiple times, if the vendor so wishes to limit usage.

The proximity detector 186 uses the data communication device 188 to either communicate to the interaction server 150 to determine participants who are in close proximity to locations of interest to the vendor (such as within a venue) or uses other means such as NFC, Infrared, Wi-Fi, or BLUETOOTH® technology to detect participants in a given area. Knowing the number of participants attending a venue can provide valuable information to a vendor regarding the success of a given promotion or special because not all participants may even claim their rewards. Thus, seeing participation numbers will give a more accurate count of success. Moreover, a venue may wish to offer certain specials only when a sufficient number of participants are present.

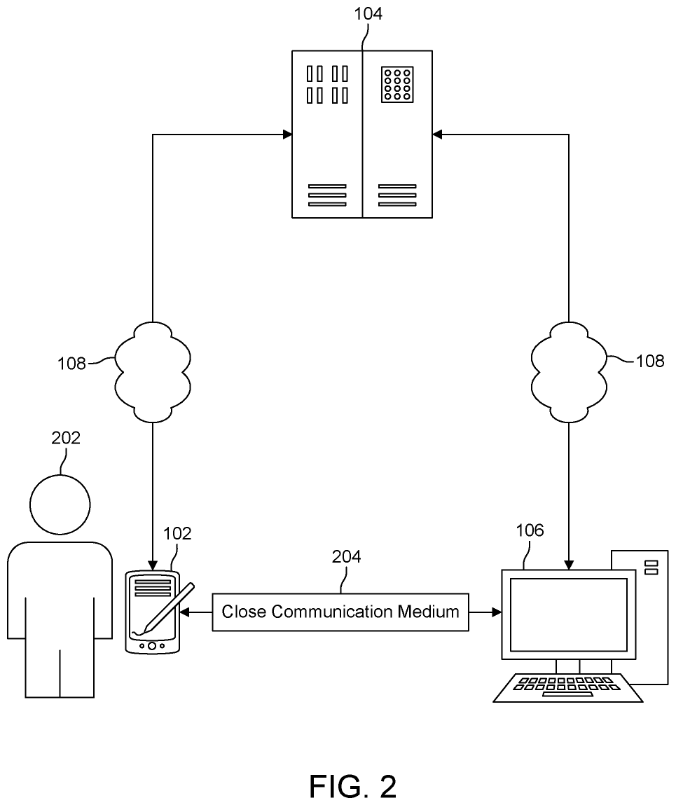

FIG. 2 shows an example system in which embodiments of the present invention may be employed, showing the interaction of a user 202 using a handheld client device 102 configured to communicate with a vendor device 106.

A user 202 may use a handheld client device to communicate with the interaction system 104 via a network 108. The interaction system 104 may also communicate with a vendor device 106 via the network 108.

When the user 202 enters a venue in which the vendor device 106 operates, their handheld client device 102 may be informed by the interaction system 104 via the network 108 that the vendor is offering a special benefit for system participants. The user may then approach the vendor to claim the special. When the user 202 places their handheld client device 102 near the vendor device 106, the vendor device 106 may read information from the handheld client device 102 via a close communication medium 204 such as infrared, NFC, BLUETOOTH®, or other wireless communication, including wireless TCP/IP or cellular communication. Once the devices have communicated, the vendor may determine via the vendor device 106 link to the interaction system 104, that the user has not yet received the benefit for the evening. The vendor may then provide the user 202 with the advertised benefit.

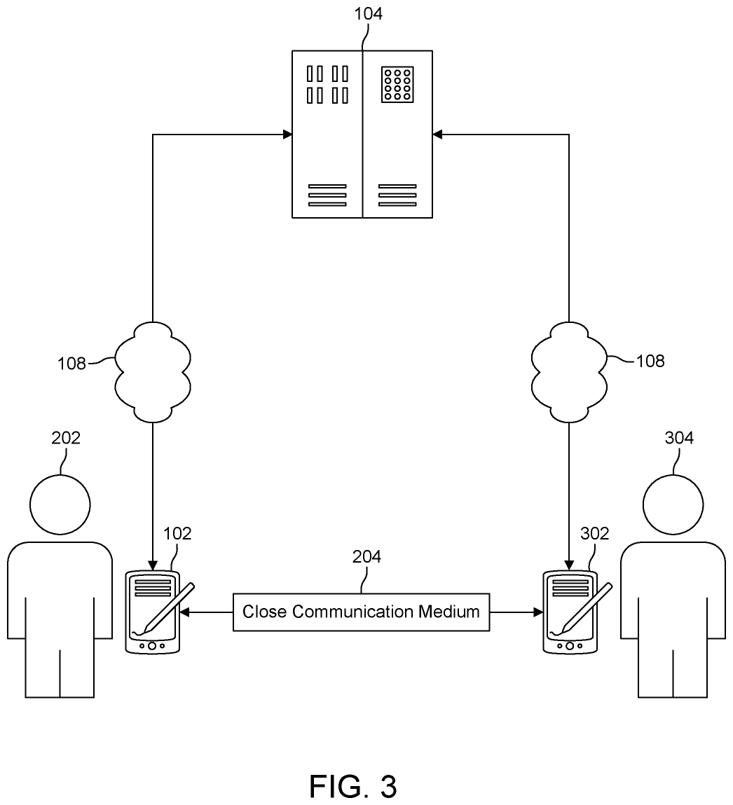

FIG. 3 shows an example system in which embodiments of the present invention may be employed, showing the interaction of a user 202 using a handheld client device 102 configured to communicate with another user 304 using another handheld client device 302.

A user 202 may use a handheld client device 102 to communicate with the interaction system 104 via a network 108. The interaction system 104 may also communicate with the handheld client device 302 of the other user via the network 108.

When the handheld client device 102 of user 202 enters a venue in which the handheld client device 302 of user 304 is located, the handheld client device 102 may be informed by the interaction system 104 via the network 108 that the other user 304 is present. When the handheld client device 102 of user 202 approaches the handheld client device 302 of user 304 to introduce themselves, the two users may place their devices (i.e., handheld client device 102 and the handheld client device 302) in close proximity to communicate. The user 202 handheld client device 102 may communicate information related to the user 202 character or other information as necessary. Similarly, the handheld client device 302 of a user 304 may communicate information related to the user 304. One or both users may receive benefits from the interaction, such as fame, items, etc. by further communicating their meeting to the interaction system 104.

In one embodiment, when handheld client device 102 and handheld client device 302 are approximately 5 feet away, they communicate across a close communication medium 204. In one example use case, user 202 and user 304 approach each other carrying their respective handheld client devices 102, 302 within 5 feet in order for handheld client device 102 and handheld client device 302 to communicate across a close communication medium 204. That close communication medium may, in that example, be infrared communication. Handheld client device 102 and handheld client device 302 may then communicate with the interaction system 104 via network 108 to record the meeting between user 202 and user 304. The interaction system 104 may process the messages from the handheld client device 102 and handheld client device 302 and communicate a message back to the handheld client device 102 and handheld client device 302 regarding items gained, specials achieved, or in-application benefits from the meeting.

In another embodiment, handheld client device 102 and handheld client device 302 are placed within a few centimeters of one another to communicate across a close communication medium 204 that may be nearfield communication. In another example use case, user 202 and user 304 may place their handheld client device 102 and handheld client device 302 within a few centimeters of one another to communicate across a close communication medium 204 that may be nearfield communication. The handheld client device 102 and handheld client device 302 may then communicate with the interaction system 104 via network 108 to record the meeting between the user 202 and user 304. The interaction system 104 may process the messages from the handheld client device 102 and handheld client device 302 and communicate a message back to the handheld client device 102 and handheld client device 302 regarding items gained, specials achieved, or in-application benefits from the meeting. Similar embodiments may include handheld client device 102 and handheld client device 302 communicating with one another via BLUETOOTH®, Wi-Fi, or other close communication mediums 204 now known or future developed.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the FIGS. 1-3 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for influencing human behavior, comprising:
a database configured to store a plurality of communication rules;
a proximity detector configured to:
receive location information from one or more mobile devices over a network, and
determine, for each of the one or more mobile devices, a client-device proximity indicating the proximity between the mobile device and each other of the one or more mobile devices; and
an interaction controller configured to:
communicate, over the network, an informational message to at least one of the one or more mobile devices based at least on the mobile-device proximity of the at least one mobile device and at least one of the plurality of communication rules, thereby causing the at least one mobile device to output an audiovisual content item.

2. The system according to claim 1, wherein the informational message contains at least one of (i) a vendor-related offer, (ii) character-related information, (iii) item information, (iv) proximity information associated with at least one of the one or more mobile devices, or (iv) any combination of (i), (ii), (iii), and (iv).

3. The system according to claim 1, wherein the interaction controller is further configured to:
receive a client-device message from at least one of the one or more mobile devices;
process the client-device message based on at least one the plurality of rules; and
transmit another informational message to at least the one of the one or more mobile devices.

4. The system according to claim 3, wherein the received client-device message contains information related to communication between the client-device and another client-device over a close communication medium.

5. The system according to claim 4, wherein the close communication medium comprises one of the following: (i) infrared communication; (ii) nearfield communication; (iii) Wi-Fi; or (iv) any combination of (i-iii).

6. The system according to claim 1, further comprising:
the interaction controller further configured to receive, over the network, a vendor-message from a vendor device, a the vendor-message containing at least the vendor information.

7. The system of claim 1 wherein the proximity information communicated to a handheld client device includes data indicating at least (i) a location of at least one other handheld client device, (ii) a distance between two or more mobile client devices, or both (i) and (ii).

8. The system of claim 7, wherein the proximity information communicated to the one or more mobile devices includes data indicating at least (i) a location of the vendor device, (ii) a distance between at least one of the one or more mobile devices and the vendor device, or both (i) and (ii).

9. The system according to claim 1, wherein the interaction controller is further configured host communications among the one or more mobile devices.

10. A method for influencing human behavior, comprising:
storing a plurality of communication rules;
receiving location information from one or more mobile devices over a network;
determining for each of the one or more mobile devices, a client-device proximity indicating the proximity between the mobile device and each other of the one or more mobile devices; and
communicating, over the network, an informational message to at least one of the one or more mobile devices based at least on the mobile-device proximity of the at least one mobile device and at least one of the plurality of communication rules, thereby causing the at least one mobile device to output an audiovisual content item.

11. The method according to claim 10, wherein the informational message contains at least one of (i) a vendor-related offer, (ii) character-related information, (iii) item information, (iv) proximity information associated with at least one of the one or more mobile devices, or (iv) any combination of (i), (ii), (iii), and (iv).

12. The method according to claim 10, further comprising:
receiving a client-device message from at least one of the one or more mobile devices;
processing the client-device message based on at least one the plurality of rules; and
transmitting another informational message to at least the one of the one or more mobile devices.

13. The method according to claim 12, wherein the received client-device message contains information related to communication between the client-device and another client-device over a close communication medium.

14. The method according to claim 13, wherein the close communication medium comprises one of the following: (i) infrared communication; (ii) nearfield communication; (iii) Wi-Fi; or (iv) any combination of (i-iii).

15. The method according to claim 10, further comprising: receiving, over the network, a vendor-message from a vendor device, a the vendor-message containing at least the vendor information.

16. The method of claim 10 wherein the proximity information communicated to a handheld client device includes data indicating at least (i) a location of at least one other handheld client device, (ii) a distance between two or more mobile client devices, or both (i) and (ii).

17. The method of claim 16, wherein the proximity information communicated to the one or more mobile devices includes data indicating at least (i) a location of the vendor device, (ii) a distance between at least one of the one or more mobile devices and the vendor device, or both (i) and (ii).

18. The method according to claim 10, further comprising:
hosting communications among the one or more mobile devices.

19. A non-transitory computer-readable medium having stored thereon one or more sequences of instructions for causing one or more processors to perform:
storing a plurality of communication rules;
receiving location information from one or more mobile devices over a network;
determining for each of the one or more mobile devices, a client-device proximity indicating the proximity between the mobile device and each other of the one or more mobile devices; and
communicating, over the network, an informational message to at least one of the one or more mobile devices based at least on the mobile-device proximity of the at least one mobile device and at least one of the plurality of communication rules, thereby causing the at least one mobile device to output an audiovisual content item.
